(19) United States
(12) Patent Application Publication
(10) Pub. No.: US 2015/0277891 A1
(43) Pub. Date: Oct. 1, 2015

(54) ELECTRONIC CONTROLLER SOFTWARE CODING SYSTEM AND METHOD FOR VEHICLE CONTROL

(71) Applicant: Hyundai Motor Company, Seoul (KR)

(72) Inventor: Jeong Min Choi, Ulsan (KR)

(21) Appl. No.: 14/338,943

(22) Filed: Jul. 23, 2014

(30) Foreign Application Priority Data
Mar. 28, 2014 (KR) 10-2014-0036936

(51) Int. Cl. G06F 9/445; H04L 29/08; H04L 29/06

(52) U.S. Cl. CPC G06F 8/65; H04L 67/42; H04L 67/1097

(57) ABSTRACT

An electronic controller software coding system and method for a vehicle control are provided. The method includes registering by a management server, a new version software for a vehicle control in a database and automatically transmitting, by the management server, the registered new version software to a coding server located at a remote site. The coding server is configured to receive and store the new version software and detect whether the quality test result of the new version software is approved. In response to determining whether the quality test result is approved the coding server is configured to install the new version software in the corresponding electronic controller.

### CROSS-REFERENCE TO RELATED APPLICATION

This application is based on and claims under 35 U.S.C. §119(a) priority from Korean Patent Application No. 10-20140036936, filed on Mar. 28, 2014 in the Korean Intellectual Property Office, the disclosure of which is incorporated herein in its entirety by reference.

### BACKGROUND

1. Field of the Invention

The present invention relates to an electronic controller software coding system and method for a vehicle control which electrically distributes the latest developed software for a vehicle control to reduce distribution costs of the software and to rapidly apply the software to a vehicle.

2. Description of the Related Art

To accurately control an engine and other apparatuses according to each driving state of a vehicle, a plurality of electronic control units (ECUs) configured to perform different functions are equipped within the vehicle. In particular, the ECU is operated by algorithm set at the time of a release of a vehicle (e.g., when the vehicle is manufactured), in which data associated with an operation of the ECU are stored in a ROM (e.g., memory) of the ECU. A function of the ECU tends to be rapidly developed and the function of the ECU may be newly added. Therefore, for the purpose of improving functions and performance of the vehicle and the ECU, modifying software errors, and the like, a software design is frequently changed. Whenever the software design is changed, the software of the ECU is required to be upgraded. An operation of upgrading the software of the ECU is referred to as coding.

Traditionally, when an engineering order (EO) for an ECU software specification is distributed from a vehicle manufacturer, a part supplier of the ECU flashes (codes) corresponding software in the ECU and delivers the software to overseas factories through shipment. The time required from shipment to delivery is different for each overseas factory and when considering duration of inventory and exhaustion of the ECU in which old versions of the software present in a factory is equipped, it takes a substantial amount of time to apply the latest software to production. Rather, when the EO for an urgent software change is distributed due to a serious quality problem, overseas factories need to be urgently supplied with the ECU, in which the latest software is equipped, from the part suppliers through air transportation and many logistical costs are involved with such a distribution and a considerable amount of time is still required. Therefore, traditionally, even though the EO for the latest software change of the ECU is distributed, the latest software may not be immediately applied to the ECU.

### SUMMARY

The present invention provides an electronic controller software coding system and method for a vehicle control which may electrically distribute latest developed software for a vehicle control to reduce distribution costs of the software and to more rapidly apply the software to a vehicle.

According to an exemplary embodiment of the present invention, an electronic controller software coding system for a vehicle control may include: a management server configured to manage software that operates the electronic controller for a vehicle; and a coding server configured to receive the software from the management server to code the software in the corresponding electronic controller, wherein when new version software is registered in a database, the management server may be configured to automatically transmit the corresponding new version software to the coding server. The management server may include: a software management module configured to register and manage the new version software in the database; and an engineering order management module configured to manage an engineering order for the new version software. The software management module and the engineering order management module may both be operated by a processor.

The engineering order may include information regarding a design change of the new version software. The coding server may include: a communication module configured to communicate with the management server to receive the new version software transmitted from the management server, an interface configured to be connected to a coder, and a controller configured to operate the coder to install the new version software in the corresponding electronic controller. The coder may include: a coding module configured to code the new version software in the electronic controller based on the operation of the controller, and a connection module configured to be connected to the electronic controller. The connection module may be implemented as a slot connector type. The controller may be configured to detect a quality test result of the new version software and in response to determining that the quality test result of the new version software is approved, code the new version software. The quality test result may include whether an initial sample inspection report (ISIR) is approved.

According to another exemplary embodiment of the present invention, an electronic controller software coding method for a vehicle control may include: registering, by a management server, new version software for a vehicle control in a database; automatically transmitting, by the management server, the registered new version software to a coding server located at a remote site; receiving and storing, by the coding server, the new version software; detecting, by the coding server, whether the quality test result of the new version software is approved; and in response to determining whether the quality test result is approved, coding, by the coding server, the new version software in the corresponding electronic controller.

In the automatically transmission, when a predetermined time elapses after the new version software is registered, the management server may be configured to transmit the registered new version software to the coding server. In the detection of whether the quality test result is approved, the coding server may be configured to detect whether an initial sample inspection report of the new version software is approved. In the coding process, the coder may be configured to replace old version software installed in the electronic controller with the new version software. In addition, the electronic controller software coding method for a vehicle control may further include: transmitting a coded result to the management server when the coding of the new version software is completed. The coded result may include a vehicle body number to which the new version software may be first applied, an electronic controller serial number, and a coding date.

### BRIEF DESCRIPTION OF THE DRAWINGS

The above and other objects, features and advantages of the present invention will be more apparent from the following detailed description taken in conjunction with the accompanying drawings.

FIG. 1 is an exemplary block configuration diagram illustrating an electronic contoller software coding system for a vehicle control according to an exemplary embodiment of the present invention;

FIG. 2 is an exemplary block configuration diagram illustrating a management server illustrated in FIG. 1 according to an exemplary embodiment of the present invention;

FIG. 3 is an exemplary block configuration diagram illustrating a coding server illustrated in FIG. 1 according to an exemplary embodiment of the present invention; and

FIG. 4 is an exemplary flow chart illustrating an electronic controller software coding method for a vehicle control according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described with reference to the accompanying drawings.

According to an exemplary embodiment of the present invention, when a vehicle manufacturer distributes an engineering order (EO) for a software change of an electronic controller (ECU), the changed latest software may be registered in a bill of material (BOM) sever of the vehicle manufacturer and the BOM server may be configured to automatically transmit the latest software to servers of a manufacturing plant and a service center. Therefore, according to the exemplary embodiment of the present invention, the latest software changed in the manufacturing plant and the service center may be more rapidly applied to the ECU by electrically distributing the latest software to the manufacturing plant and the service center.

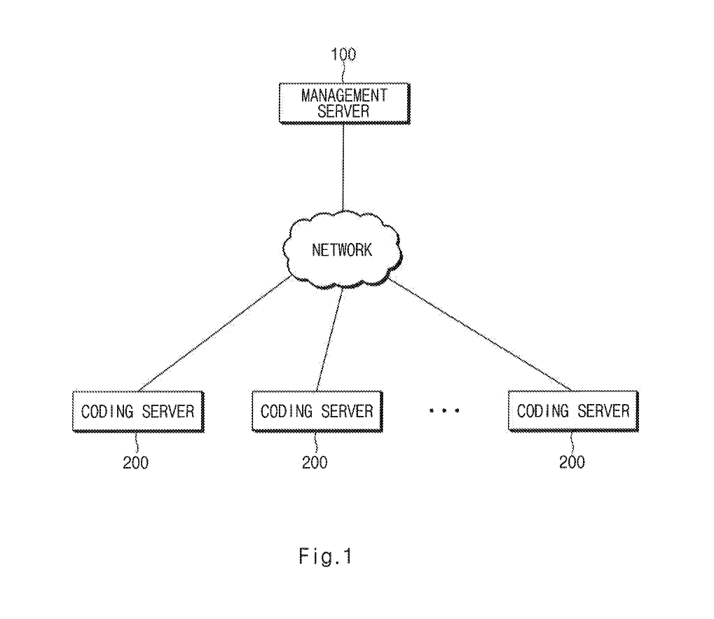

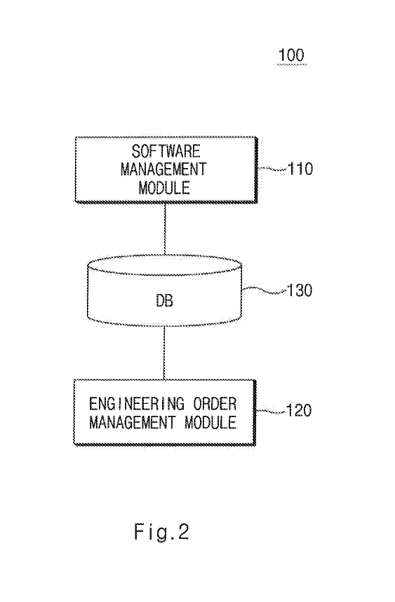

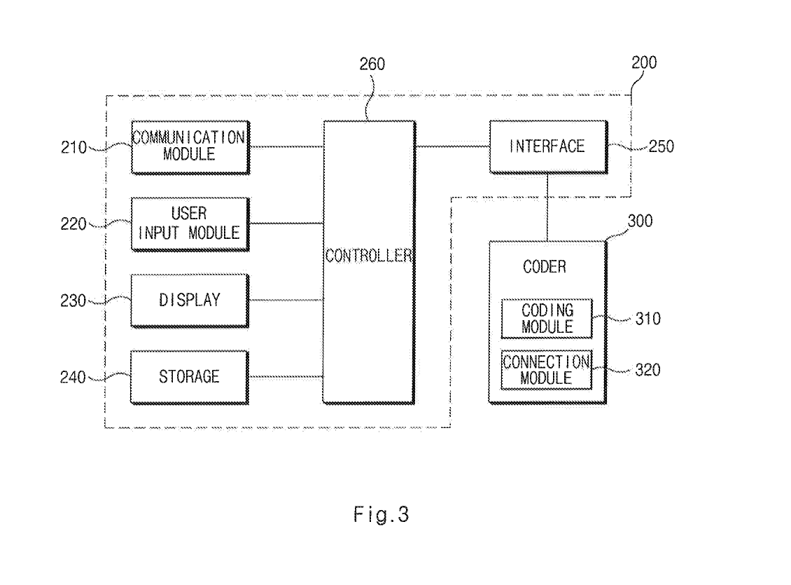

FIG. 1 is an exemplary block configuration diagram illustrating an electronic controller software coding system for a vehicle control according to an exemplary embodiment of the present invention, FIG. 2 is an exemplary block configuration diagram illustrating a management server illustrated in FIG. 1, and FIG. 3 is an exemplary block configuration diagram illustrating a coding server illustrated in FIG. 1.

As illustrated in FIG. 1, the electronic contoller software coding system for a vehicle control may include a management server 100 connected via a network and a plurality of coding servers 200. In this configuration, the network may be implemented as a wireless LAN (Wi-Fi), a personal area network (PAN), a local area network (LAN), a wide area network (WAN), a value added network (VAN), a metropolitan area network (MAN), an integrated service digital network (ISDN), and the like. The management server 100 may be configured to manage software for a vehicle control which operates an ECU equipped within a vehicle and calibration data which are variables defined to execute each function of the ECU. Further, the management server 100 may also be configured to manage the engineering order (EO) that includes information regarding a design change of the software for a vehicle control.

As illustrated in FIG. 2, the management server 100 may include a software management module 110, an engineering order management module 120, and a database (hereinafter, referred to as ‘DB’) 130. The software management module 110 may be executed by a processor to register new version software (e.g., latest software) of which the design (e.g., specification) is changed according to a request of a developer or a manager in the DB 130 and manage the software using a classification code. When the new version software is registered in the DB 130, the software management module 120 may be configured to automatically transmit the registered new version software to the coding server 200. In particular, the software management module 110 may be configured to transmit the new version software immediately after the new version software is registered, after a predetermined time elapses, or at a defined time.

The software management module 110 may correspond to a BOM server used in the manufacturer of the vehicle for the bill of material. The engineering order management module 120 may be executed by the processor to register, distribute, and manage the engineering order (EO) that includes the information regarding the software design change in the DB 130. In particular, the design change information may include a design change ground, a change content, an applied vehicle model, a change date, and the like and the engineering order may include an EO number, a product number, and the like. The DB 130 may be executed by the processor to store the software for a vehicle control for each version, the calibration data, and the engineering order, and the like.

The management server 100 may be configured to transmit the engineering order to the coding server 200 during the transmission of the new version software. The coding server 200 may be installed in the manufacturing plant which produces the ECU and the service center. When the new version software is received from the management server 100, the coding server 200 may be configured to detect whether a quality test for the corresponding new version software is approved and code the software in the corresponding ECU. Further, the management server 200 may be configured to rapidly notify the manager of the manufacturing plant (e.g., the vehicle manufacturing plant) and the service center that the new version software is received. In particular, the management server 200 may be configured to notify the manager of a new registration of engineering order via a manufacturing plant communication network using text message, electronic mail, and the like.

As illustrated in FIG. 3, the coding server 200 may include a communication module 210, a user input module 220, a display 230, a storage 240, an interface 250, and a controller 260. The controller 260 may be configured to execute the communication module 210, the user input module 220, the display 230, the storage 240, and the interface 250. The communication module 210 may be configured to communicate with the management server 100 via the network. Further, the communication module 210 may be configured to receive the new version software automatically transmitted from the management server 100. The user input module 220 may be configured to receive data from a user (e.g., a user input) and may be implemented as a keypad, a touch pad, a touch screen, and the like. The user input module 220 may be configured to receive from a user a production instruction (e.g., ranking instruction), that instructs the ECU to apply the new version software.

The display 230 may be configured to display a progress situation and result in response to the operation of the coding server 200. The display 230 may be a liquid crystal display (LCD), a light emitting diode (LED) display, a flexible display, a transparent display, and the like. The display 230 may be implemented in a touch screen type coupled with a touch pad. The storage 240 may be configured to store the software (e.g., old version and/or new version) for a vehicle control received from the management server 100, the calibration data, and various data. The interface 250 may be configured to connect external devices to the coding server 200. In particular, the external device may be a coder 300. The coder 300 may include a coding module 310 configured to code (e.g., install) the software for a vehicle control in the ECU according to the operation of the coding server 200 and a connection module 320 that connects the ECU to the coder 300.

When the software equipped in the ECU is not present, the coding module 310 may be configured to install the new version software in the ECU and when the old version software previously installed in the ECU is present, the old version software may be deleted and upgraded to the new version software. When the connection module 320 may be manufactured in a slot connector form, the ECU may be mounted in the corresponding slot connector and then the new version software may be coded in the ECU. Further, the connection module 320 may be directly connected to the electronic controller via the slot connector and may also be connected to the ECU equipped within the vehicle via an on board diagnostics terminal as an insertable connector type.

When the production instruction to which the new version software is applied is received through the user input module 220, the controller 260 may be configured to operate the coder 300 to install the new version software in the corresponding ECU. The controller 260 may be configured to detect the quality test result of the new version software to confirm whether the quality test for the corresponding new version software is approved and in response to determining that the quality test result is approved, instruct the coder 300 to code the new version software in the ECU. The test result may include whether an initial sample inspection report (ISIR) is approved based on the ISO regulation.

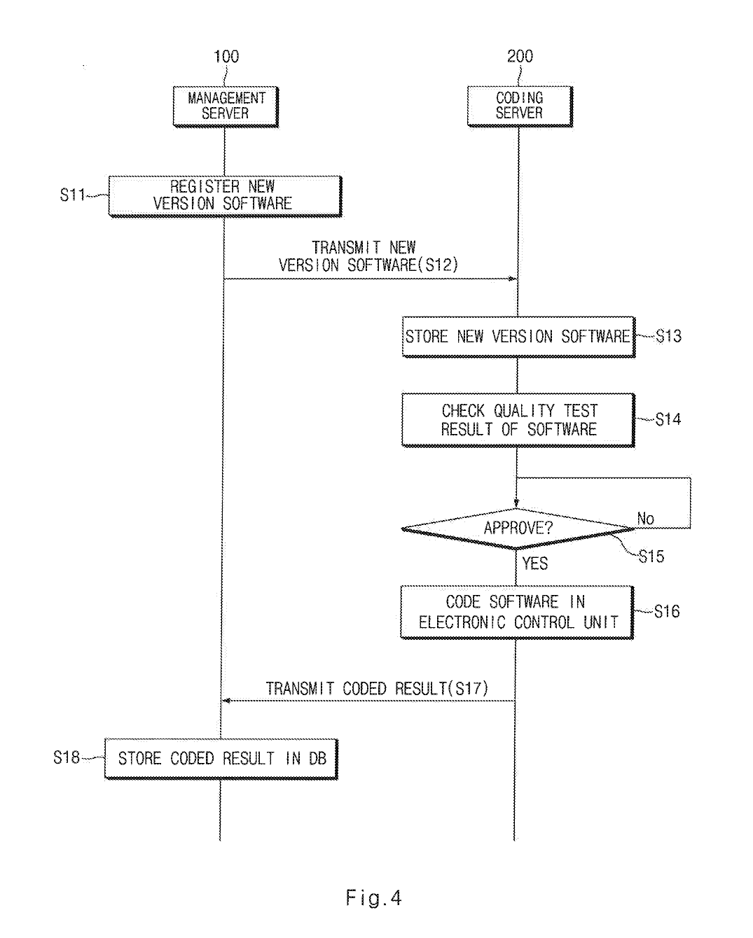

FIG. 4 is an exemplary block configuration diagram illustrating an electronic controller software coding method for a vehicle control according to another exemplary embodiment of the present invention. First, the management sever 100 may be configured to register the new version software for operating the ECU in the DB 130 according to the request of the user (e.g., developer and manager) (S11). In particular, the user may access the management server 100 via the terminal to request the registration of the engineering order that includes the new version software for a vehicle control of which the design is changed and the design change information regarding the new version software. When a new engineering order is registered, the engineering order management module 120 of the management server 100 may be configured to notify a person in charge of a production line and the service center of the registration of the engineering order (e.g., notify the manufacturing or service center of the engineering order). In particular, the management server 100 may be configured to transmit a notification that notifies the registration of the engineering order to the pre-registered person in charge (e.g., to a predetermined location, computer, center, person, or the like) in a form of text message, electronic mail, and the like.

The management server 100 may be configured to register the new version software in the DB 130 and then automatically transmit the registered new version software to the coding server 200 (S12). The management server 100 may be configured to transmit the new version software immediately after the new version software is registered, after a predetermined time elapses, or at a defined time. The coding server 200 may be configured to receive the new version software transmitted from the management server 100 and store the received new version software in the storage (e.g., memory) 240 (S13).

Further, the coding server 200 may be configured to detect the quality test result of the new version software (S14). In particular, the quality test result detects whether the initial sample inspection report (ISIR) is approved based on the ISO regulation. When the coding server 200 receives the production instruction of the new version software, the coding server 200 may be configured to detect a specification regarding whether the new version software is a later version than the old version software (e.g., is a later developed version or a newer version). Further, when the new version software is the latest version, the coding server 200 may be configured to detect whether the ECU is connected to the coder 300 and in response to determining that the coder 300 is connected to the ECU, detect whether the initial sample inspection report (ISIR) of the new version software is approved.

When the quality test result is approved, the coding server 200 may be configured to install (e.g., code) the new version software in the corresponding ECUs (S16). The coding server 200 may be configured to stall the new version software in the ECU connected to the coder 300, via the coder 300. In particular, when the old version software is present in the ECU, the coding server 200 may be configured to replace the old version software with the new version software. The coding server 200 may be configured to output the coding progress to the display 230 to output the progress to a user. When the coding is completed, the coding server 200 may be configured to transmit the coded result to the management server 100 (S17). The coded result may include a vehicle body number to which the new version software is first applied, an ECU serial number, software version information, a coding date, and the like. When the management sever 100 may be configured to receive the coded result from the coding server 200 and store and manage the received coded result in the DB 130 (S18).

The exemplary embodiments of the present invention describe that the latest ECU software may be electronically distributed to allow the manufacturing plant and the service center located at a remote site to code the latest software in the ECU, but may electronically distribute the calibration data in addition to the latest ECU software. When the latest calibration data are electronically distributed, the manufacturing plant and the service center may store the latest calibration data in the memory ROM of the ECU.

As described above, according to the exemplary embodiments of the present invention, the latest ECU software and the latest calibration data may be electronically distributed to the manufacturing plant and the service center located at a remote site and therefore the latest software and data may be more rapidly applied to the ECU.

According to the exemplary embodiments of the present invention, the latest software for a vehicle control may be electronically distributed, such that the distribution costs may be saved and the software may be applied to products. Therefore, according to the exemplary embodiments of the present invention, it may be possible to save the logistical costs, the part costs, and the after-service costs. Further, the software of which the design is changed may be applied to products within shorter time period without the restriction of the distance from the service center or manufacturing plant. Additionally, the software may be managed by a computer and therefore may be systematically managed, such that the software change history and the products result tracking management may be facilitated and the leakage of defective software may be prevented.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An electronic controller software coding system for a vehicle control, comprising:
a management server configured to manage software for operating the electronic controller for a vehicle; and
a coding server configured to receive the software from the management server to install the software in the corresponding electronic controller,
wherein when a new version software is registered in a database, the management server automatically transmits the corresponding new version software to the coding server.

2. The electronic controller software coding system for a vehicle control according to claim 1, wherein the management server includes:
a software management module configured to register and manage the new version software in the database; and
an engineering order management module configured to manage an engineering order for the new version software.

3. The electronic controller software coding system for a vehicle control according to claim 2, wherein the engineering order includes information regarding a design change of the new version software.

4. The electronic controller software coding system for a vehicle control according to claim 1, wherein the coding server includes:
a communication module configured to communicate with the management server to receive the new version software transmitted from the management server;
an interface configured to be connected to a coder; and
a controller configured to operate the coder to install the new version software in the corresponding electronic controller.

5. The electronic controller software coding system for a vehicle control according to claim 4, wherein the coder includes:
a coding module configured to install the new version software in the electronic controller according to the operation of the controller; and
a connection module configured to be connected to the electronic controller.

6. The electronic controller software coding system for a vehicle control according to claim 5, wherein the connection module is implemented as a slot connector type.

7. The electronic controller software coding system for a vehicle control according to claim 4, wherein the controller is configured to detect a quality test result of the new version software and in response to determining that the quality test result of the new version software is approved, install the new version software.

8. The electronic controller software coding system for a vehicle control according to claim 7, wherein the quality test result includes whether an initial sample inspection report (ISIR) is approved.

9. An electronic controller software coding method for a vehicle control, comprising:
registering, by a management server, a new version software for a vehicle control in a database;
automatically transmitting, by the management server, the registered new version software to a coding server located at a remote site;
receiving and storing, by the coding server, the new version software;
detecting, by the coding server, whether the quality test result of the new version software is approved; and
in response to determining whether the quality test result is approved, installing, by the coding server, the new version software in a corresponding electronic controller.

10. The electronic controller software coding method for a vehicle control according to claim 9, wherein in the automatically transmission, when a predetermined time elapses after the new version software is registered, the management server is configured to transmit the registered new version software to the coding server.

11. The electronic controller software coding method for a vehicle control according to claim 9, wherein in the detection of whether the quality test result is approved, the coding server is configured to detect whether an initial sample inspection report of the new version software is approved.

12. The electronic controller software coding method for a vehicle control according to claim 9, wherein in the coding, the coder is configured to replace old version software installed in the electronic controller with the new version software.

13. The electronic controller software coding method for a vehicle control according to claim 9, further comprising:
transmitting, by the coding server, a coded result to the management server when the coding of the new version software is completed.

14. The electronic controller software coding method for a vehicle control according to claim 13, wherein the coded result includes a vehicle body number to which the new version software is first applied, an electronic controller serial number, and a coding date.

15. A non-transitory computer readable medium containing program instructions executed by a contoller, the computer readable medium comprising:
program instructions that receive a new version software from a management server for a vehicle control;
program instructions that store the new version software;
program instructions that detect whether the quality test result of the new version software is approved; and
program instructions that install the new version software in a corresponding electronic controller in response to determining whether the quality test result is approved.

16. The non-transitory computer readable medium of claim 15, further comprising:
program instructions that detect whether an initial sample inspection report of the new version software is approved.

17. The non-transitory computer readable medium of claim 15, further comprising:
program instructions that replace old version software installed in the electronic controller with the new version software.

18. The non-transitory computer readable medium of claim 15, further comprising:
program instructions that transmit a coded result to the management saver when the coding of the new version software is completed.

19. The non-transitory computer readable medium of claim 18, wherein the coded result includes a vehicle body number to which the new version software is first applied, an electronic controller serial number, and a coding date.
